(19) United States
(12) Patent Application Publication
(10) Pub. No.: US 2009/0231179 A1
(43) Pub. Date: Sep. 17, 2009

(54) ARRANGEMENT, SYSTEM AND METHOD FOR THE WIRELESS CONTROL OF AN APPARATUS

(75) Inventor: Alfred Bruhn, Karlsruhe (DE)

Correspondence Address: MCCORMICK, PAULDING & HUBER LLP, CITY PLACE II, 185 ASYLUM STREET, HARTFORD, CT, 06103, US

(73) Assignee: MAQUET GmbH & Co. KG, Rastatt (DE)

(21) Appl. No.: 12/336,869

(22) Filed: Dec. 17, 2008

(30) Foreign Application Priority Data
Dec. 18, 2007 (DE) 10 2007 060 810.3

(51) Int. Cl. G08C 19/12

(52) U.S. Cl. 341/176

(57) ABSTRACT

The invention relates to an arrangement, a system as well as methods for the wireless control of a device, in each of which a device (10) having at least one transponder (40a to 40m) and at least one actuating element (12 to 36) assigned to the transponder (40a to 40m), to which actuating element a control function of the apparatus is assigned, is used in order to activate and/or deactivate the control function of the apparatus.

### CROSS REFERENCE TO RELATED APPLICATIONS

Applicant hereby claims foreign priority benefits under U.S.C. § 119 from German Patent Application No. 10 2007 060810.3 filed on Dec. 18, 2007, the contents of which are incorporated by reference herein.

### TECHNICAL FIELD

The invention relates to an arrangement, a system and a method for the wireless control of an apparatus, in particular for the wireless control of a medical apparatus.

### BACKGROUND ART

By means of the wireless control, in particular an electronically controlled, motor-driven operating table consisting of at least one function module can be remotely controlled and remotely actuated. In use many medical machines and apparatuses require operator actions which can be initiated via an appropriate human-machine-interface (HMI). For an easier operation, for example in the course of a treatment, such as a surgery in an operating room, it can be advantageous to provide the human-machine-interface in addition to a further human-machine-interface firmly connected to the respective medical apparatus or machine or as a sole human-machine-interface in the form of a hand-held instrument, preferably a remote control. With the aid of a remote control, the operation of the respective medical apparatus can take place from a position remote from the apparatus. In the case of wire-connected remote controls, an actuating element required for an operating function can be integrated into the current path of a respective actuator. Dependent on the operating functions to be provided, given a wire-connected remote control a plurality of signal lines are to be provided between the apparatus and the remote operating unit.

For remotely controlling an apparatus, further wireless remote controls are known with the aid of which apparatuses can be controlled. Such remote controls generally require an own energy supply, for example by way of batteries or accumulators arranged in the remote control. With the aid of such remote controls, a data exchange generally takes place between the remote control and a receiving unit connected to the control unit of the apparatus.

From the document US 2006/020267737 A1 a remote control having an RFID tag is known that can be activated via an activation switch so that the communication with this RFID tag is only possible in the activated state of the activation switch. As a result thereof, an inadvertent read-out of the RFID tag is avoided. With the aid of this remote control an identity control of a person can be performed. However, from this document it is not known to directly perform a control function for controlling an apparatus upon actuation of a switch.

### BRIEF SUMMARY OF THE INVENTION

The object of the invention is to provide an arrangement, a system and a method for the wireless control of an apparatus, by means of which the wireless control of the apparatus to be controlled can be performed easily and safely.

This object is solved for an arrangement, a system and a method by the subject-matters of the respective independent claims. Advantageous developments of the invention are given in the dependent claims.

What is achieved by an arrangement for the wireless control of an apparatus is that a control function for the control of the apparatus can be initiated by actuation of an actuating element in that the transponder transmits respective data to a remotely arranged communication unit connected to a control unit of the apparatus or a communication unit integrated into this control unit so that the control function for the control of the apparatus can be performed.

It is particularly advantageous when the arrangement serves for the wireless control of a medical apparatus. According to the invention, medical machines are preferably likewise regarded as medical apparatuses. Preferably, the medical apparatus is an operating table. As an actuating element, preferably a switching element, for example a push button or a reed contact, can be provided. The device is preferably a remote control.

As a transponder in particular passive half-active or active transponders are suitable. These can in particular be realized as passive half-active or active RFID tags. The energy supply of the transponders at least with the energy required for the communication with a communication unit can take place via a respective wireless coupling with an energy supply unit, the energy supply unit preferably being a part of the communication unit. As a result thereof, the energy required for the operation of the transponder is supplied to the transponder in a wireless way. The wireless communication between each transponder used for the remote control and at least one communication unit preferably takes place in the UHF transmission band. At least the data transferred from the transponders to the communication unit are encrypted, preferably with the aid of a suitable cryptography method. The device is preferably a hand-held transmitter for the wireless control of the medical apparatus, preferably a wireless remote control.

The control function which is initiated by the actuation of one of the actuating elements in particular causes the activation and/or deactivation of a drive, in particular of an adjusting drive and/or a drive for a locking element.

It is advantageous to short-circuit the receiving circuit of at least one transponder in one switch position of the actuating element, an energy supply unit transmitting at least the energy required by the transponder for the communication with at least one communication unit to the receiving circuit in an electric, inductive and/or electromagnetic way. By short-circuiting the receiving circuit of at least one transponder it can be determined whether in the communication area of the communication unit at least one transponder has a short-circuited receiving circuit. This can, for example, be determined by an analysis of the energy transferred to the transponders by the energy supply unit.

The device according to the invention preferably includes no exchangeable battery and no chargeable accumulator so that the maintenance requirements for the exchange of the batteries and for charging the accumulators can be omitted. Further, the arrangement can be produced easily and cost-efficiently and the interruption-free function is guaranteed as a result of the non-required additional energy sources integrated into the arrangement.

As transponders in particular multi-channel transponders are suitable, which optionally communicate via one of the available communication channels with at least one communication unit. As a result thereof, a communication with several transponders can take place simultaneously without the respective communication being affected or blocked by the communication of the further transponders with the communication unit. Thus, collisions in the communication of the transponders with the communication unit are avoided.

It is particularly pointed out that the methods specified in the independent claims and the specified system, too, can each be developed with features of individual dependent arrangement claims or, respectively, respective method or system features and/or further features specified in the description in connection with the inventive arrangements or inventive methods.

### BRIEF DESCRIPTION OF THE DRAWINGS

Further features and advantages of the invention result from the following description which in connection with the enclosed Figures explains the invention with reference to an embodiment.

FIG. 1 shows a schematic representation of the top view of an inventive remote control with 14 actuating elements altogether.

FIG. 2 shows a block diagram of a transponder unit for use in the remote control according to FIG. 1.

FIG. 3 is a schematic representation of the transponder units arranged in the remote control according to FIG. 1.

### DETAILED DESCRIPTION OF THE INVENTION

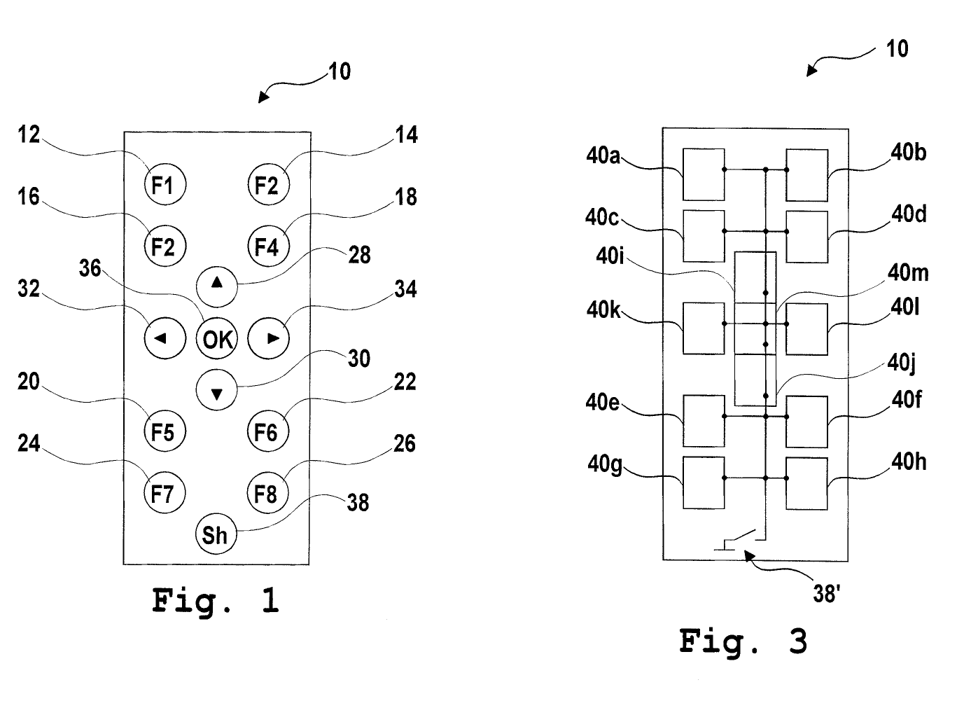

In FIG. 1 a top view of a remote control 10 is illustrated which has 14 actuating elements 12 to 38 altogether. The actuating elements 12 to 38 are realized as push buttons, each of which is connected to a transponder unit and activates or deactivates this transponder unit upon actuation of the push button and/or influences the information sent from the transponder unit. Special operating functions F1 to F8 of an operating table are assigned to the actuating elements 12 to 26. With the aid of these operating functions, for example, segments of the operating table which are to be actuated can be selected which can then be moved with the aid of the actuating elements 28 to 34. A selection and/or an adjustment can, for example, be confirmed with the aid of the actuating element 36. For activation of further functions an actuating element 38 is provided which serves as a shift key and with the aid of which a further control function assigned to the actuating elements 12 to 26 can each time be activated. Alternatively or additionally, the shift key 38 can be used in order to activate the control function of the actuating elements 12 to 36 at all, then, for activation, the control functions assigned to the actuating elements 12 to 36 being activated only when the respective actuating element 12 to 36 and the actuating element 38 are simultaneously activated. As a result thereof, an inadvertent operation by way of unintentional pressing of one of the actuating elements 12 to 36 can be prevented. The additional actuation of the control function with the aid of the actuating element 38 can also only be provided for one further actuating element 12 to 36 or for a part of the actuating elements 12 to 36 and/or be made dependent on further signals and/or information.

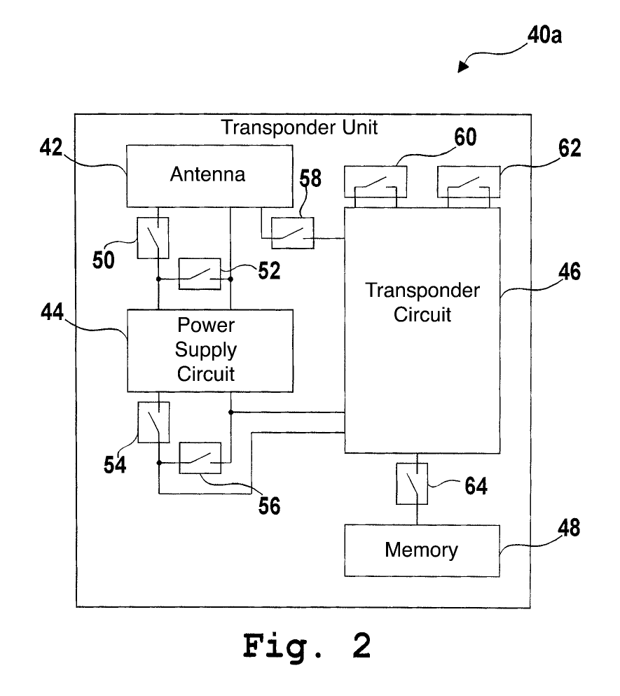

In FIG. 2, a transponder unit 40a is illustrated which comprises an antenna formed by a receiving circuit 42, a power supply circuit 44, a transponder circuit 46 and a memory 48. The receiving circuit 42 is implemented like a coil, preferably as a printed circuit, the winding ends of which are electrically connected to the power supply circuit 44 via the switching element 50. With the aid of the switching element 50, the circuit between the power supply circuit 44 and the receiving circuit 42 can be short-circuited. With the aid of the switching element 52, the receiving circuit 42 can be closed. For data transfer, the receiving circuit 42 of the antenna can be electrically connected to the transponder circuit 46 via the switching element 58. The power supply circuit 44 can be electrically connected to the transponder circuit 46 via the switching element 54. Further, the power supply circuit 44 can be short-circuited with the aid of the switching element 56. Signal inputs of the transponder circuit 46 are electrically connected to the switching elements 60, 62 so that the transponder circuit 46 can detect the switching states of these switching elements 60, 62. Further, the transponder circuit 46 is connected over a signal line with the memory 48 via the switching element 64. For the provision of the switching function of an actuating element, only one of the switching elements 50 to 64 is required. However, more than one switching element 50 to 64 can be provided in the transponder unit 40a, as a result whereof several different control functions can be performed by different information or, respectively, data with corresponding information emitted by the transponder unit 40a as a response.

In FIG. 3, the remote control 10 according to FIG. 1 is illustrated, the upper cover of the remote control illustrated in FIG. 1 being removed and the transponder units 40a to 40m arranged within the housing of the remote control 10 being shown. Each of the transponder units 40a to 40m is further connected to the switching unit 38′ assigned to the actuating element 38 in order to activate the transponder units 40a to 40m by an actuation of the switching element 38′ and/or to effect an alternative control function of the actuating elements 12 to 36. In the present embodiment the transponder units 40a to 40m have the same structure as the transponder unit 40a according to FIG. 2. Further, the transponder units 40a to 40m are in the present embodiment each formed as 1-bit or multi-bit transponder units, the transponder units 40a to 40m being formed as passive transponders, preferably as RFID transponders. Preferably, the transponder units 40a to 40m are formed as multi-channel transponders in order to reduce the collision possibilities upon query of the transponder units 40a to 40m by a communication unit or, respectively, read unit. Additionally or alternatively to the use of several parallel transmission channels, further anti-collision strategies can be used, in particular to each of the transponder units 40a to 40m communicating on the same channel a time window can be assigned in which the transponder unit 40a to 40m transmits data to the read unit after a transmission request by the read unit. In the memory 48, both the data to be transmitted given different switching states of the switching elements 50 to 64, in particular given different switching states of the switching elements 60, 62, as well as the keys required for the encryption of such data and used for the cryptographic encryption of data to be sent and/or decryption of received data are stored.

Further, it is advantageous to arrange several read units at a distance to one another and to determine each of the angles of at least one transponder unit 40a to 40m with respect to the read units so that the position of the remote control 10 can be determined by a control unit with the aid of the determined angle information. With the aid of the positions determined, it can be checked whether the remote control 10 is in a suitable distance to the operating table to be actuated with the aid of the remote control 10 and/or to another medical apparatus to be actuated with the aid of the remote control 10. As a result, inadvertent operations of the operating table or the other medical apparatus can be safely avoided.

The remote control 10 can in the same manner be used for further medical apparatuses and machines as well as for non-medical apparatuses and machines and is not restricted to this use. The remote control 10 preferably has no internal energy sources, in particular no exchangeable batteries and no accumulators. However, half-active transponders can be used, to which the energy required for communication with a communication unit is supplied via the receiving circuit of the antenna 42 and the power supply circuit 44, which however provide the energy required for the operation of the transponder circuit 64 itself by an internal energy source. It is advantageous to use so-called UHF-RFID transponder units or other transponders allowing a sufficient distance between the remote control and the read unit. The safe communication between the remote control 10 or, respectively, the transponder units 40a to 40m and at least one read unit can be improved by the provision of several read units in the area around the apparatus to be actuated. Preferably, the read areas of the read units arranged in a room overlap one another so that at each point in the room, for example an operating room, a communication between the remote control 10 and the read unit or, respectively, a control unit for the control of the apparatus connected with the read units is possible. The read units can be connected over data lines, preferably a network such as a LAN (local area network) or a wireless data connection such as a WLAN data connection (wireless local network), an infrared data connection, a bluetooth data connection or another suitable network and/or data connection, to the control unit or the control units of the apparatus to be controlled or, respectively, actuated with the aid of the remote control 10.

A unique identification of a remote control and/or an actuating element can in particular be achieved by the header information, the so-called transponder header, transferred to the read device by a transponder unit 40a to 40m. This is particularly helpful when several remote controls 10 are present or, respectively, detected in the area of the at least one read device for detecting the information transferred by the transponder unit 40a to 40m and/or several transponder units 40a to 40m having the same function are present or, respectively, detected in the detection area of the at least one read unit. Further, it is likewise possible to transfer information from the read device to the transponder unit 40a to 40m and store these settings in the transponder unit 40a to 40m and/or to automatically carry out settings corresponding to this information and to configure the transponder unit 40a to 40m accordingly. As a result, in particular the coding of at least one transponder unit 40a to 40m can be adapted to the requirements of the apparatus to be actuated.

While the present invention has been illustrated and described with respect to a particular embodiment thereof, it should be appreciated by those of ordinary skill in the art that various modifications to this invention may be made without departing from the spirit and scope of the present invention.

What is claimed is:

1. An arrangement for the wireless control of an apparatus,
comprising a device which has at least one transponder to which at least one actuating element is assigned, at least one control function for the control of the apparatus being assigned to the actuating element.

2. The arrangement according to claim 1, wherein the device has at least two transponders, to each of which at least one actuating element is associated, at least one control function for the control of the apparatus being assigned to each of the actuating elements.

3. The arrangement according to claim 1, wherein at least one actuating element assigned to the transponder activates and/or deactivates the transponder
and/or in that at least one actuating element assigned to the transponder activates and/or deactivates the data transfer of the transponder
and/or in that by means of the actuating element each information transferred with the aid of the data transfer between the transponder and a remotely arranged communication unit can be changed.

4. The arrangement according to claim 1, wherein the control function activates and/or deactivates a drive, in particular an adjusting drive and/or a drive for a locking element.

5. The arrangement according to claim 1, wherein the actuating element is a switching element, preferably a push button.

6. The arrangement according to claim 5, wherein the switching element has a reed contact.

7. The arrangement according to claim 1, wherein each transponder communicates at least in one switching state of the respective actuating element with a communication unit, preferably a read unit, the communication unit being connected with a control unit of the apparatus.

8. The arrangement according to claim 1, wherein the transponders are passive transponders, half-active or active transponders, preferably passive half-active or active RFID tags.

9. The arrangement according to claim 1, wherein the energy supply of the transponders at least with the energy required for the communication with a communication unit takes place each time via a wireless coupling with an energy supply unit, the energy supply unit preferably being a part of the communication unit.

10. The arrangement according to claim 1, wherein at least the wireless communication between each of the transponders and at least one communication unit takes place in the UHF transmission band.

11. The arrangement according to claim 1, wherein at least the data transferred from the transponders to the communication unit is encrypted.

12. The arrangement according to claim 1, wherein the device is a hand-held transmitter for the wireless control of the apparatus, preferably a wireless remote actuator or remote control, the controlled apparatus preferably being an operating table.

13. The arrangement according to claim 12, wherein by the actuation of one of the actuating elements at least a drive and/or locking element of the apparatus is activated and/or deactivated.

14. The arrangement according to claim 1, wherein the actuating element short-circuits the receiving circuit of at least one transponder in a switching state of the actuating element, an energy supply unit transferring at least the energy required by the transponder for the communication with at least one communication unit to the receiving circuit in an electric and/or electromagnetic manner.

15. The arrangement according to claim 1, wherein the device contains no exchangeable battery and no chargeable accumulator.

16. The arrangement according to claim 1, wherein at least two of the transponders are multi-channel transponders, which optionally communicate via one of the available communication channels, preferably on different communication channels, with at least one communication unit.

17. A system having an arrangement for the wireless control of an apparatus according to claim 1, wherein the system has at least two spaced-apart communication units for the wireless communication with the device, each of the communication units being connected to the control unit of the device.

18. The system according to claim 17, wherein the control unit determines the position of the device by the determination of the position of at least one transponder of the device, preferably with the aid of a direction finding system.

19. The system according to claim 18, wherein at least three communication units are provided, the distance between each of the communication units and at least one of the transponders of the device being determined, on the basis of the distance determined with respect to each communication unit a position of the device relative to the communication units being determined.

20. The system according to claim 17, wherein the control unit of the apparatus activates and/or deactivates at least one drive and/or locking element of the apparatus dependent on the data transferred by the arrangement.

21. A method for the wireless control of an apparatus,
in which data are transferred in a wireless manner between at least one transponder of a device, to which at least one actuating element is assigned, and at least one communication unit connected with a control unit of the apparatus to be controlled and/or a communication unit comprised by the control unit,
upon actuation of the actuating element the transfer of data between the transponder, to which the actuating element is assigned, and the communication unit is made possible or prevented,
and in which upon actuation of the actuating element assigned to the transponder at least one control function for the control of the apparatus is performed.

22. A method for the wireless control of an apparatus,
in which data are transferred in a wireless manner between at least two transponders of a device, to each of which at least one actuating element is assigned, and at least one communication unit connected to a control unit of the apparatus to be controlled and/or a communication unit comprised by the control unit,
upon actuation of the actuating element the transfer of data between the respective transponder, to which the actuating element is assigned, and the communication unit is made possible or prevented,
and in which upon actuation of the actuating element assigned to the respective transponder at least one control function for the control of the apparatus is performed each time.

23. The method according to claim 21, wherein at least two communication units are provided, each of the communication units effecting a communication with at least one transponder of the device and determining the angle and/or the distance to the transponder.

24. The method according to claim 17, wherein an anti-collision method for the communication between the at least one communication unit and the at least two transponders of the device is used, by way of which a time range, in particular a time slot for the communication with the communication unit is assigned to each transponder.

25. The method according to claim 17, wherein the position of at least one transponder and/or of the device is determined two-dimensionally or three-dimensionally in space relative to the communication units and/or to the apparatus.

26. The method according to claim 17, wherein a multiple symmetric cryptographic encryption of the data transferred between the respective transponder and the communication unit is carried out.

27. The method according to claim 17, wherein energy is transferred by inductive coupling, capacitive coupling and/or electromagnetic waves from an energy supply unit to the respective transponder.

28. The method according to claim 1, wherein the communication unit repeatedly sends data, by means of which the transponders are requested to transfer data to the communication unit, preferably in a determined time interval after the receipt of the data sent by the communication unit.

29. The method according to claim 25, wherein the control function is only activated upon actuation of the actuating element when the determined position of the transponder lies in a predetermined area, preferably when the transponder has a distance to at least one communication unit and/or to the apparatus that is smaller than a predetermined maximum distance.

30. The method according to claim 29, wherein the distance is determined in a direction-dependent manner and/or in that the predetermined maximum distance is determined in a direction-dependent manner.
